(19) United States
(12) Patent Application Publication
(10) Pub. No.: US 2016/0069531 A1
(43) Pub. Date: Mar. 10, 2016

(54) LED LAMP

(71) Applicant: HON HAI PRECISION INDUSTRY CO., LTD., New Taipei (TW)

(72) Inventor: CHEN-HAN LIN, Tu-Cheng (TW)

(21) Appl. No.: 14/526,174

(22) Filed: Oct. 28, 2014

(30) Foreign Application Priority Data
Sep. 9, 2014 (TW) 103130972

(51) Int. Cl. F21V 7/00; F21V 7/05

(52) U.S. Cl. CPC F21V 7/0066; F21V 7/05; F21Y 2101/02

(57) ABSTRACT

An LED lamp includes a substantially enclosed space and an LED light source. The substantially enclosed space includes a first incident element and a second incident element located on the opposite sides thereof, an first portion connecting top ends of the first incident element and the second incident element and a second portion connecting with bottom ends of the first incident element and the second incident element. The second portion includes a first reflective plate and a second reflective plate bended from a top end of the first reflective plate. An angle between the first incident element and the first reflective plate, and an angle between the second incident element and the second reflective plate are less than an angle between the first reflective plate and the second reflective plate. The LED light source is below a top end of the second portion.

### CROSS-REFERENCE TO RELATED APPLICATIONS

This application claims priority to TW Patent Application No. 103130972 filed on Sep. 9, 2014 in the China Intellectual property Office, the contents of which are incorporated by reference herein.

### FIELD

The disclosure relates to an LED lamp.

### BACKGROUND

Referring to FIG. 1, the prior art disclosure an LED lamp typically includes a substantially enclosed space 10, an LED 20 mounted on one end of the substantially enclosed space 10 and a reflective plate 40 relatively mounted on the other end of the substantially enclosed space 10. An first portion 14 is formed on a side of the substantially enclosed space 10 and a reflecting layer 30 is on the other side of the substantially enclosed space 10 opposite to the first portion 14. Light from the LED 20 is reflected by the reflective plate 40 and reflecting layer 30 to radiate outwardly from the first portion 14. However, the light from the small angle of the LED 20 is prone to radiate outward from the substantially enclosed space 10 where the LED 20 is arranged.

### BRIEF DESCRIPTION OF THE DRAWINGS

Implementations of the present technology will now be described, by way of example only, with reference to the attached figures.

FIG. 1 is a cross sectional view of an LED lamp of the prior art.

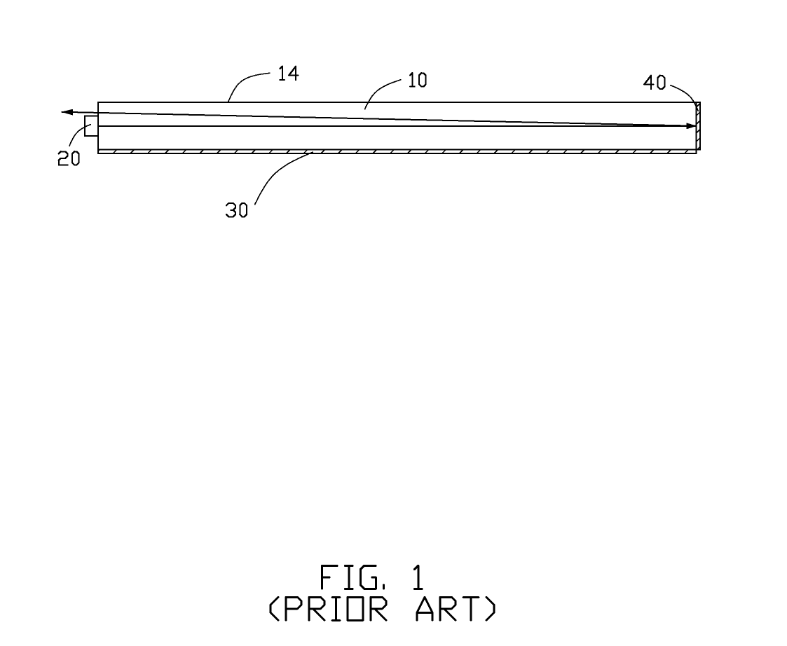

FIG. 2 is a cross sectional view of an LED lamp in accordance with a first embodiment of the present disclosure.

FIG. 3 is a cross sectional view of an LED lamp in accordance with a second embodiment of the present disclosure.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. The description is not to be considered as limiting the scope of the embodiments described herein.

A definition that applies throughout this disclosure will now be presented. The term “comprising” means “including, but not necessarily limited to”; it specifically indicates open-ended inclusion or membership in a so-described combination, group, series and the like.

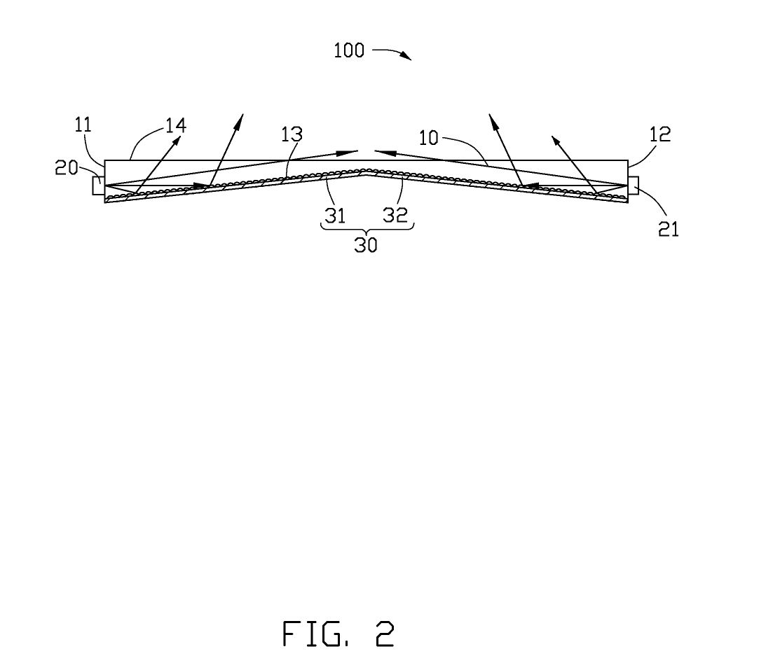

Referring to FIG. 2, an LED lamp 100 of a first embodiment includes a substantially enclosed space 10, a first LED 20, a second LED21 and a second portion 30 mounted a side of the substantially enclosed space 10.

The substantially enclosed space 10 includes a first incident element 11 and a second incident element 12 opposite to and substantially to the first element 11, and a connecting element. The connecting element connecting the outer edges of the first incident element 11 to the outer edges of the second incident element 12, the connecting element has a first portion 14 and a second portion 30. A dispersion layer 13 connecting bottom ends of the first incident element 11 and the second incident element 12. The second portion 30 is on an outer surface of the dispersion layer 13. The second portion 30 also connects bottom ends of the first incident element 11 and the second incident element 12.

The cross section of the second portion 30 is V-shaped. A center of the second portion 30 extends toward the first portion 14. A height of the second portion 30 is gradually decreased from a center to opposite ends of the second portion 30. The height of the center of the second portion 30 is more larger than the height of the first LED 20 and the height of the second LED 21.

The second portion 30 is made of high reflectivity material and is used to reflect the light from the first LED 20 and the second LED 21 toward the first portion 14. The second portion 30 includes a first reflective plate 31 and a second reflective plate 32 bended from a top end of the first reflective plate 31. The first reflective plate 31 connects the bottom end of the first incident element 11. The second reflective plate 32 connects the bottom end of the second incident element 12. The first reflective plate 31 and the second reflective plate 32 connect with each other below the center of the substantially enclosed space 10.

A first angle defined between the first reflective plate 31 and the first incident element 11 is equal to a second angle defined between the second reflective plate 32 and the second incident element 12. The first reflective plate 31 extending from the first incident element 11 toward the second incident element 12 at the first angle toward the first portion 14 of the connecting element, the second reflective plate 32 extending from the second incident element 12 toward the first incident element 11 at the second angle toward the first portion 14 of the connecting element. The first reflective plate 31 connecting to the second reflective plate 32 at a third angle defined between the first reflective plate 31 and the second reflective plate 32. The first angle and the second angle are less than the third angle. The first LED 20 and the second LED 21 are below a top end of the second portion 30.

It is further understood that the first angle must not be equal to the second angle. The first angle and the second angle can be designed for the actually demand.

The dispersion layer 13 is a film and mounted on a top surface of the second portion 30. The dispersion layer 13 is formed by a plurality of protruded portions to make the light exiting evenly. The profile of the dispersion layer 13 is the same of that of the second portion 30.

The first LED 20 is positioned on an outer surface of the first light incident element 11 and the second LED is positioned on an outer surface of the second light incident element 12. A top end of the first LED 20 and the top end of the second LED 21 are below of a top end of the second portion 30. Some light from the first LED 20 and the second LED 21 radiating directly through the first portion 14, and the other light from the first LED 20 and the second LED 21 radiating through the first portion 14 is reflected by the second portion 30.

Referring to FIG. 2, most of the light from the first LED 20 and the second LED 21 radiating towards the first reflective plate 31 and the second reflective plate 32 is reflected by the first reflective plate 31 and the second reflective plate 32 to exit through the first portion 14. A few light from the first LED 20 and the second LED 21 radiating towards the first portion 14 exit through the first portion 14. The present disclosure avoids the light radiating through the first incident element 11 and the second incident element 12 to improve the luminous efficiency.

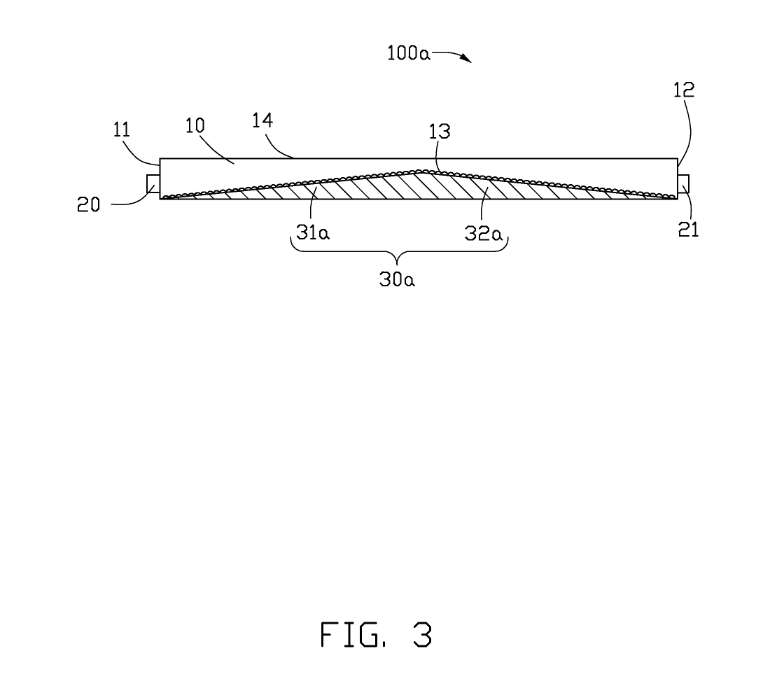

Referring to FIG. 3, an LED lamp 100a of a second embodiment is similar to that of the first embodiment. The LED lamp 100a includes a second portion 30a, the second portion 30a integrates with the substantially enclosed space 10 and the cross section of the second portion 30a is a triangle. The second portion 30a includes a first reflective plate 31a and a second reflective plate 32a, the cross section of the first reflective plate 31a and the second reflective plate 32a are also a triangle. The first reflective plate 31a connects the bottom end of the first incident element 11 and the second reflective plate 32a connects the bottom end of the second incident element 12. An out surface of the second portion 30a is formed by a bottom of the first reflective plate 31a and the second reflective plate 32a and is parallel with the first portion 14.

It is to be further understood that even though numerous characteristics and advantages have been set forth in the foregoing description of embodiments, together with details of the structures and functions of the embodiments, the disclosure is illustrative only; and that changes may be made in the details, including in matters of shape, size, and arrangement of parts within the principles of the disclosure to the full extent indicated by the broad general meaning of the terms in which the appended claims are expressed.

The embodiments shown and described above are only examples. Many details are often found in the art such as the other features of an LED package. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

1. An LED lamp comprising:
a substantially enclosed spaced formed by:
a first incident element;
a second incident element opposite to and substantially parallel to the first incident element; and
a connecting element connecting the outer edges of the first incident element to the outer edges of the second incident element, the connecting element having a first portion and a second portion;
a first light emitting diode positioned on an outer surface of the first light incident element; and
a second light emitting diode positioned on an outer surface of the second light incident element;
wherein, the second portion of the connecting element includes:
a first reflective plate extending from the first light incident element toward the second light incident element at a first angle toward the first portion of the connecting element; and
a second reflective plate extending from the second light incident element toward the first light incident element at a second angle toward the first portion of the connecting element; and
wherein, the first reflective plate connecting to the second reflective plate at a third angle, the first angle and the second angle being less than the third angle, and
wherein the first portion of the connecting element, the first incident, the second incident element and the second portion of the connecting element connect to each other end to end to cooperatively define a hermetical space therebetween; and
wherein the first reflective plate directly connects the bottom end of the first incident element and the second reflective plate directly connects the bottom end of the second incident element.

2. The LED lamp of claim 1, wherein the first LED and the second LED are below a top end of the second portion.

3. The LED lamp of claim 1, wherein an ends of the first reflective plate and the second reflective plate forms a end of the second portion.

4. The LED lamp of claim 1, wherein the cross section of the second portion is a triangle.

5. The LED lamp of claim 1, wherein the cross section of the second portion is a V-shaped.

6. (canceled)

7. The LED lamp of claim 1, wherein the first reflective plate and the second reflective plate connect with each other below the center of the substantially enclosed space.

8. The LED lamp of claim 1, wherein the first angle is equal to the second angle.

9. The LED lamp of claim 1, wherein the first angle must not be equal to the second angle.

10. The LED lamp of claim 1, wherein a dispersion layer is mounted on an top surface of the second portion.

11. The LED lamp of claim 10, wherein the dispersion layer is formation of a plurality of protruded portions.

12. The LED lamp of claim 10, wherein the dispersion layer connects bottom ends of the first incident element and the second incident element.

13. The LED lamp of claim 10, wherein the dispersion directly contacts with the second portion.

14. The LED lamp of claim 1, wherein a top end of the first LED and a top end of the second LED are below of a top end of the second portion.

15. The LED lamp of claim 1, wherein each of the first reflective plate and the second reflective plate are smooth plates.
